(19) United States
(12) Patent Application Publication
(10) Pub. No.: US 2010/0230853 A1
(43) Pub. Date: Sep. 16, 2010

(54) METHOD FOR PRINTING PLASTIC INJECTION MOLDING

(76) Inventor: Yen-Pin Su, Yongkang city (TW)

Correspondence Address: LEONG C LEI, PMB # 1008, 1867 YGNACIO VALLEY ROAD, WALNUT CREEK, CA, 94598, US

(21) Appl. No.: 12/400,806

(22) Filed: Mar. 10, 2009

(51) Int. Cl. B29C 45/00

(52) U.S. Cl. 264/220

(57) ABSTRACT

Disclosed is a method for printing a surface of a non-planar injection-molded object, wherein a thin plastic sheet is provided and printed with a desired pattern. A mold corresponding to a desired final product of injection molding is provided to press the plastic sheet so as to form a plastic shell that has a shape corresponding to the final product and can compliantly positioned in an injection mold. The plastic shell is positioned in an injection mold to combine with a plastic injection molding made with the injection mold. The pattern printed on the plastic sheet is shown on an inside surface of the final product through the plastic shell that is formed by hot pressing the plastic sheet and tightly combined with the final product so as to directly molded with the final product and is not susceptible to color fading or detachment due to abrasion, impact or washing.

### TECHNICAL FIELD OF THE INVENTION

The present invention generally relates to a method for printing a non-planar object, wherein a thin plastic sheet is provided and printed with a desired pattern or character and the plastic sheet is hot pressed to form a plastic shell shaped corresponding to a desired injection molded object, so that in carrying out an injection molding operation, the plastic shell is first positioned in an injection mold to eventually combine with the injection molded article to show the printed pattern on a surface of the non-planar object.

### DESCRIPTION OF THE PRIOR ART

Conventionally, printing performed on a plastic article is only workable for a planar article, which is done by first carrying out primary injection molding with a patterned mold to form a semi-product. Ink may then be applied to the semi-product by means of for example screen printing, or alternatively stamping or laser may be employed. Stamping or screen printing only applies ink to a surface of the injection-molded plastic semi-product and the ink is not tightly bonded to the surface of the semi-product. Due to the fact that the molded surface is only smooth, the attachment of the ink to the surface is very poor, and the ink may be easily detached from the surface caused by abrasion or impact. It is even worse that when a secondary injection molding is carried out, the plastic semi-product may get softened due to the high temperature of injection molding and the ink that is attached to the surface of the plastic semi-product may get melted and burred due to being subjected to high temperature and high pressure. Consequently, the throughput is reduced, the utility is poor, and the cost is increased. Further, this method is only applicable to planar articles and cannot be used to perform printing on a non-planar surface, such as a convex surface or a concave surface.

### SUMMARY OF THE INVENTION

The present invention relates to a method for printing an injection molding, and particularly to a method for printing a surface of a non-planar injection-molded object, wherein a thin plastic sheet is provided and printed with a desired pattern or characters. A mold that is shaped corresponding to a designed final product of injection molding is provided to press the plastic sheet so as to form a plastic shell that has a shape corresponding to the final product and can compliantly positioned in an injection mold. In carrying out an injection molding operation, the plastic shell is positioned in the injection mold to combine with a plastic injection molding. The pattern that is printed on the plastic sheet is then shown on an inside surface of the final product of injection molding through the plastic shell that is formed by hot pressing the plastic sheet and tightly combined with the final product of injection molding so as to directly molded with the final product and is not susceptible to color fading or detachment due to abrasion, impact or washing.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart showing a method for printing a plastic injection molding having a non-planar surface in accordance with the present invention.

FIG. 2 is a schematic view showing a plastic sheet in accordance with the present invention.

FIG. 3 is a schematic view illustrating the plastic sheet printed with a pattern in accordance with the present invention.

FIG. 4 is a perspective view illustrating a hot pressing mold in accordance with the present invention.

FIG. 5 is a perspective view illustrating a plastic shell in accordance with the present invention.

FIG. 6 is a schematic view illustrating injection molding in accordance with the present invention.

FIG. 7 is a schematic view illustrating a final product of an example of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

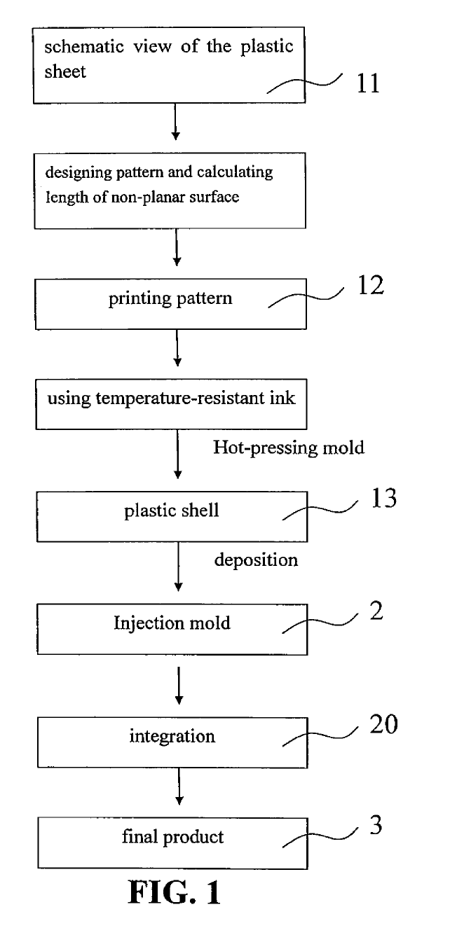

With reference to FIG. 1, which shows a flow chart of a method for printing a non-planar surface of an injection molded article, the method of the present invention starts with initially providing or preparing a mold for making a non-planar-surfaced article that has a non-planar surface and also preparing a flat sheet of plastic material. The method for performing printing in accordance with the present invention is then carried out as follows:

(1) The plastic sheet 11 is cut to a size (length) corresponding to an overall length of the non-planar surface of a final product that is intended to be made by plastic injection molding.

(2) A desired pattern 12, such as texts or figures, is printed on the plastic sheet 11 to provide a printed plastic sheet 11. The pattern 12 is obtained by first making calculation of a length thereof in accordance with the non-planar surface of the article to be molded and the applying temperature-resistant ink to print the pattern 12 on the plastic sheet 11.

(3) A mold is then provided to perform hot pressing on the plastic sheet 11 so obtained to make a plastic shell 13 corresponding in shape to an outer contour of the final product. The elaborate pattern will then follow the non-planar surface of the plastic shell 13 that is formed by the hot pressing operation.

(4) The plastic shell 13 so obtained with the pressing operation is then deposited in an injection mold 2.

(5) An injection molding operation is carried out to provide an integrated object 20.

(6) After the injection is completed, the plastic shell 13 is integrated on the surface of the injection molded product 3. Since the plastic shell 13 has a shape exactly corresponding to a desired non-planar surface of the outer contour of the final product 3, they are securely fixed together, whereby the non-planar surface of the plastic molding exhibits the pattern that is printed on the plastic shell beforehand.

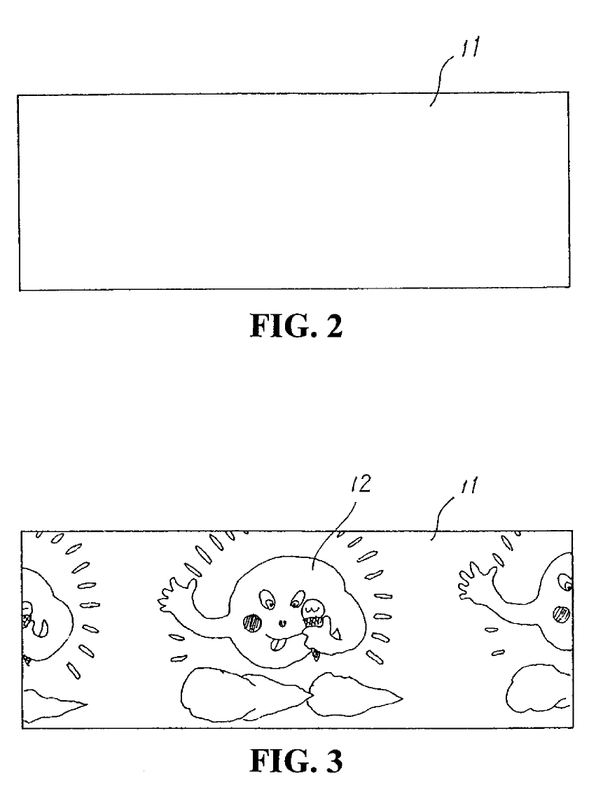

Next, reference is made to FIG. 2, a schematic view of the plastic sheet 11 is illustrated, which in the embodiment illustrated comprises a thin flat sheet and is cut to a length substantially corresponding to the overall length of the non-planar surface of a desired final product. In accordance with the pattern to be shown on different portions of the surface of the final product, a pattern 12 (as shown in FIG. 3) is properly designed and arranged and printed on the plastic sheet 11. Thus, the pattern 12 in the planar form may be greater or longer than that on the final product 3 and a temperature-resistant ink must be used to prevent the pattern 12 from being molten and getting burred during the injection molding process.

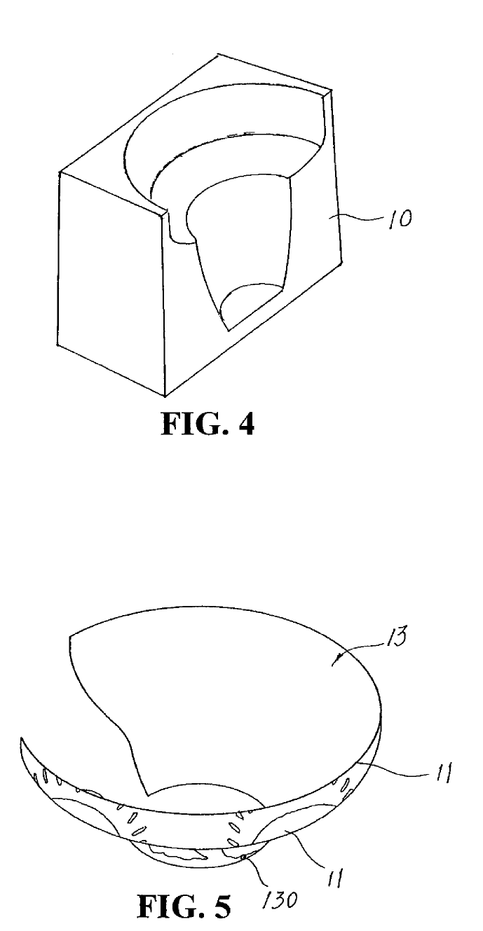

Referring to FIG. 4, a hot-pressing mold 10 is made according to the contour of the final product 3 and a hot-pressing process is carried out to press the plastic sheet 11 that is printed with the pattern 12 into a plastic shell 13 that is made a three-dimensional configuration (see FIG. 5) corresponds in shape to the non-planar surface of the final product 3, whereby the printed pattern 12 is shown on a side surface of the plastic sheet 11 by following the curving of the non-planar surface and the plastic shell 13 with the printed pattern is obtained. A filling hole 130 is formed in a bottom of the plastic shell 13.

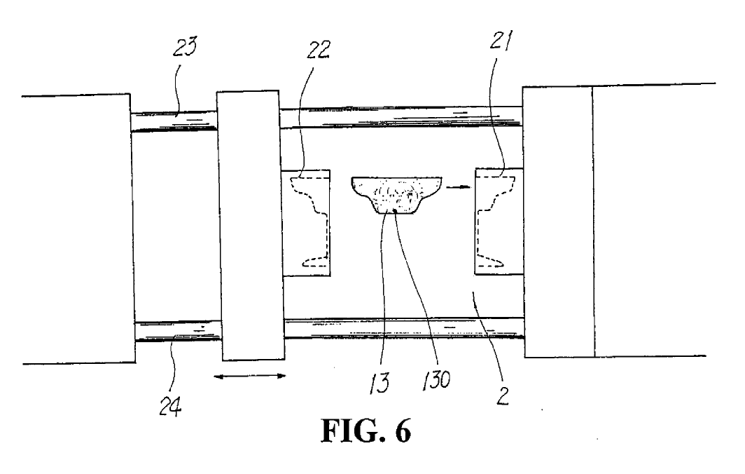

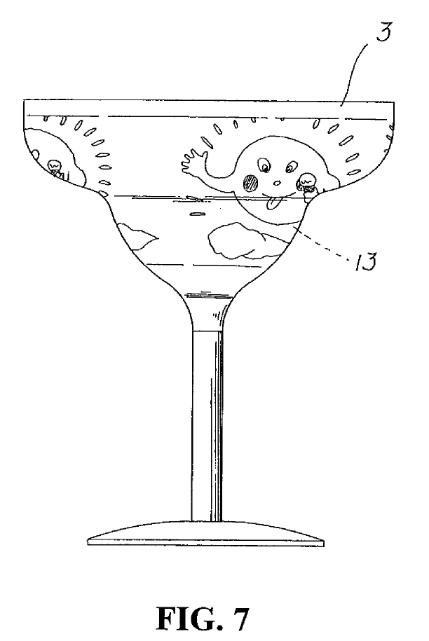

To carry out injection molding, as shown in FIG. 6, a mold 2 for making the final product is set on a machine chassis with a male molding member mounted to a fixed portion and a female molding member mounted to a movable portion and is guided to horizontally move by upper guide posts 23 and lower guide posts 24 to close and open the injection mold. In operation, the plastic shell 13 is first positioned in the male molding member 21 and the female molding member 22 is horizontally moved to close to the male molding member 21 so as to retain the plastic shell 13 in the female molding member 22. Plastic material is then introduced through a conduit connected to the filling hole 130 of the plastic shell 13 positioned inside the mold into the mold 2. This is the known injection molding technique and no further detail is needed here. The plastic material is then filled into the mold 2 through the filling hole 130 of the plastic shell 13 and bonded to and integrated with the plastic shell 13. Afterwards, when the female molding member 22 is moved in an opposite direction to open the mold, the final product 3 molded in the female molding member 22 is ejected through an ejection mechanism so that an integrated unitary object 20 can be obtained through tightly bonding the plastic shell 13 and the final product 3 together. The pattern that is printed in advance in an inside surface of the plastic shell 13 can then be shown, as a regular printing, on a non-planar surface of the final product as shown in FIG. 7. The printed patterned is located and enclosed between the plastic shell 13 and the final product 3, whereby fading or detachment of color is completely overcome and damage caused by impact or abrasion can be protected against. Color fading does not occur even the final product is brushed.

The injection molding operation taken in the present invention is the same as the conventional injection molding and the difference resides in that before the injection molding is carried out, a plastic sheet 11 is initially provided and a pattern 12 is printed on the plastic sheet 11, and hot pressing is performed on the plastic sheet 11 to form a non-planar plastic shell 13 that may have raised and recessed portions corresponding to a mold 2 for molding the final product 3. To carry out the injection molding operation, the plastic shell 13 is first positioned in the male molding member 21 of the mold 2 and the female molding member 22 is horizontally moved to close mold after which the injection molding is carried out to form an integrated unitary object 20 by bonding the plastic shell 13 and the product 3, whereby the pattern can be printed on a product 3 that has a curved or non-planar surface.

The molding method in accordance with the present invention provides advantages over the conventional ways:

(1) The injection molding step carried out in the present invention is exactly the same as the conventional injection molding, so that the injection molding machine requires no modification is carried out the method of the present invention, whereby cost will not be increased and a final product can be obtained after the injection molding to provide a fast manufacturing of the final product without secondary injection molding, leading to effective reduction of the overall manufacturing costs.

(2) The plastic sheet 11 is printed with a planar pattern 12 in advance and then a hot pressing process is used to convert the plastic sheet 11 into a three-dimensional plastic shell 13 having a non-planar surface on which the pattern 12 is shown. In carrying out injection molding, the plastic shell 13 is first positioned in an injection mold and the pattern 12 is integrated to a final injection molded product having a contour with the injection molding process. In this way, the incapability of printing a pattern on a curved surface, three-dimensional surface or a non-planar surface can be overcome and market competition power of the molded product so obtained is improved.

(3) Forming the three-dimensional plastic shell 13 that has different curved or non-planar surface by means of hot pressing the plastic sheet 11 that carries a planar printed pattern 12 in accordance with is a simple process and when the plastic shell 13 is positioned in an injection mold to carry out injection molding, the pattern 12 can be integrated to the surface of final product 3 with no burning, deformation, color detachment.

While certain novel features of this invention have been shown and described and are pointed out in the annexed claim, it is not intended to be limited to the details above, since it will be understood that various omissions, modifications, substitutions and changes in the form is and details of the device illustrated and in its operation can be made by those skilled in the art without departing in any way from the spirit of the present invention.

I claim:

1. A method for printing a plastic injection molding having a non-planar surface, comprising the following steps:
(1) providing a mold for a product having a non-planar surface and a plastic sheet;
(2) printing a pattern in a planar form on the plastic sheet;
(3) hot pressing the plastic sheet to form a plastic shell having a non-planar surface;
(4) positioning the plastic shell in the mold;
(5) carrying out an injection molding operation; and
(6) obtaining an integrated and pattern-printed plastic product having a non-planar surface after the injection molding operation.

2. The method according to claim 1, wherein the pattern in the planar form printed on the plastic sheet has a size corresponding to an overall length or width of the non-planar surface.

3. The method according to claim 1, wherein the pattern is first printed in a planar form on the plastic sheet and is converted into a three-dimensional pattern with the hot pressing of the plastic shell.
